(19) United States
(12) Patent Application Publication
(10) Pub. No.: US 2010/0228687 A1
(43) Pub. Date: Sep. 9, 2010

(54) Electricity Vending Devices And Associated Methods

(76) Inventor: Donald Davis Lewis, JR., Seattle, WA (US)

Correspondence Address: LATHROP & GAGE LLP, 4845 PEARL EAST CIRCLE, SUITE 201, BOULDER, CO, 80301, US

(21) Appl. No.: 12/710,208

(22) Filed: Feb. 22, 2010

Related U.S. Application Data
(60) Provisional application No. 61/157,091, filed on Mar. 3, 2009.

(51) Int. Cl. G06F 17/00; G06Q 30/00

(52) U.S. Cl. 705/412

(57) ABSTRACT

Electricity vending devices and methods and software for vending electrical power are disclosed. Payment information may be received by the electricity vending devices by way of a magnetic or electric card reader, a fingerprint scanner, a retinal scanner, a keypad, a touchscreen, or an RFID detector.

### RELATED APPLICATIONS

This application claims the benefit of priority of U.S. Patent Application Ser. No. 61/157,091, filed Mar. 3, 2009, which is incorporated by reference herein.

### BACKGROUND

Portable electronic devices are becoming increasingly ubiquitous. Computers, cellular phones, audio players and portable entertainment systems are examples of devices that operate and optionally recharge from public power sources. In addition, electric vehicles such as cars, trucks and personal transportation devices, such as Segways®, electric scooters and golf carts, may also charge from public power sources. With the proliferation of electrically-powered devices, the era of being able to plug into any available outlet outside of one's own home or work environment without the device-user/owner incurring power costs is coming to an end.

Various technologies for obtaining fees for electricity are known. For example, U.S. Pat. Nos. 6,466,658, 6,314,169 and 5,812,643 granted to Schelberg et al. disclose vending machines for dispersing telecommunication access and electricity. Schelberg's vending machines are configured as lockers or telephone booth structures having a work station and seat. U.S. Pat. No. 6,614,204 granted to Pellegrino et al. discloses a charging station for hybrid vehicles. Pellegrino's charging station utilizes a specific power connector and requires a parking space to be associated with it. It is not designed to charge portable electronic devices other than vehicles.

### SUMMARY

The present instrumentalities advance the art by providing electricity vending devices having unique features and, in some aspects physical dimensions adapted to fit within a space for a conventional electrical outlet—as found in most homes and offices—such that any conventional power outlet may be replaced with an electricity vending device.

In an embodiment, an electricity vending device includes an electrical outlet for supplying electricity to a user; a user interface for receiving payment information; a controller; a switch responsive to the controller for connecting and disconnecting the electricity supply to and from the electrical outlet; a meter or a timer for measuring an amount of electricity supplied to the electrical outlet; and a communication interface for sending the payment information and the amount of electricity consumed to a payment processor.

In an embodiment, a method for distributing electricity from an electricity vending device to an external electrical device includes detecting the presence or absence of a plug in an electrical outlet, receiving payment information, supplying electricity to the electrical outlet, and terminating a transaction.

In an embodiment, a software product comprises instructions, stored on computer-readable media. The instructions, when executed by a computer, perform steps for vending electricity. They include instructions for detecting the presence or absence of a plug, instructions for receiving payment information, instructions for delivering power to an outlet, and instructions for terminating an electricity vending transaction.

### BRIEF DESCRIPTION OF THE DRAWINGS

FIGS. 1A-D are exemplary planar front and side views of electricity vending devices, according to multiple embodiments.

FIG. 2 shows a block diagram of an exemplary electricity vending system, according to an embodiment.

FIGS. 3A-B show flowcharts of exemplary transaction methods for use with an electricity vending device, according to multiple embodiments.

FIG. 4 shows a block diagram of an exemplary electricity vending system, according to an embodiment.

FIGS. 5A-B show flowcharts of exemplary transaction methods for use with an electricity vending device, according to multiple embodiments.

### DETAILED DESCRIPTION

As used herein electrical power is electrical energy. The unit of electrical energy is the Watt. Electrical power may be supplied to an electrical device in the form of alternating current or direct current.

As used herein, an “outlet” is a portion of a device that electrically and mechanically couples with a receiving device to supply power. In many embodiments, an outlet will comprise a socket that mechanically couples with a plug of the receiving device. In other embodiments, “mechanical coupling” may comprise contactless mechanical coupling, such as magnetic coupling.

As used herein a “plug” is a device that couples mechanically and electrically with an outlet. A plug may be electrically connected to or embedded with an electrical device.

As used herein, “powering on” means supplying with electrical power. “Powering on” may also mean “turning on”, “applying power”, and “powering up”.

As used herein, “powering down” means ceasing the supply of electrical power. “Powering down” may also mean “turning off”, “shutting off”, “shutting down”, “removing power”, and “powering off”.

A computer software product is a machine readable device having recorded thereon a sequence of machine readable instructions for instructing a machine to perform specific tasks. The sequence of instructions may, for example, be recorded in media such as a CD, DVD, magnetic tape, magnetic disk, or memory such as EEPROM, ROM, or RAM circuitry. A machine having an embedded microprocessor with firmware or software embedded in an EEPROM or ROM therefore includes a computer software product.

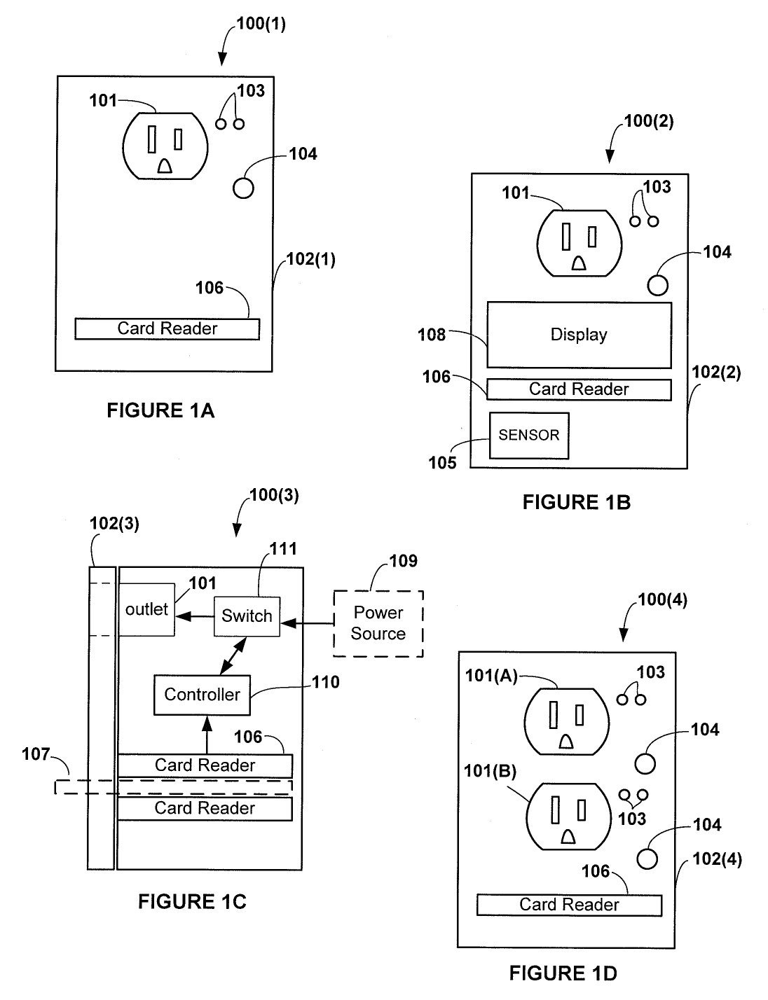

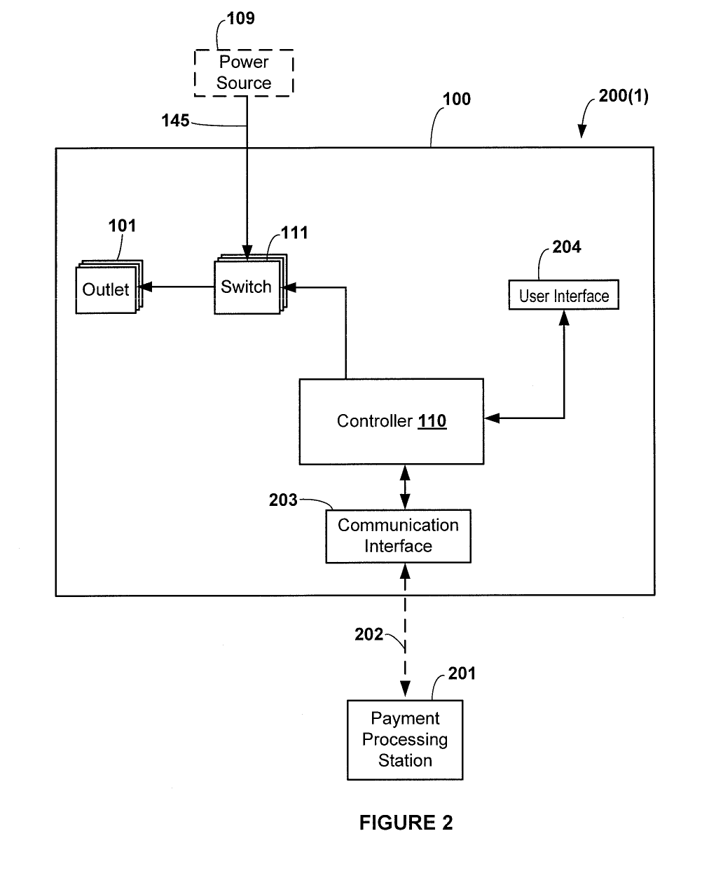

Reference will now be made to the attached drawings, where like numbers represent similar elements in multiple figures. Numbering without parentheses may be used to denote a genus (e.g., electricity vending device 100, FIG. 2), whereas numbering with parentheses denotes a species within a genus (e.g., electricity vending device 100(2), FIG. 1B).

FIG. 2 shows one exemplary electricity vending system 200(1) that includes an electricity vending device 100 and a payment processing station 201. Electricity vending device 100 receives power from an external power source 109, which may represent one or more of a battery, a power grid, a solar array and a generator. Electricity vending device 100 includes a user interface 204, a switch 111, an outlet 101, a controller 110 and a communication interface 203. User interface 204 allows a customer to interact with electricity vending device 100, and may be formed of one or more of a touchscreen, an LCD, a keypad, a speaker and a microphone. In one example of operation, a user interacts with user interface 204 to enter user data and/or payment information, which is then sent to controller 110. Controller 110 may send this information to a payment processing station 201 through communication interface 203. Communication interface 203 provides connectivity to payment processing station 201 through a real or virtual communications path 202, which may represent one or more of the Internet, a telecommunications line, and an electrical line. Switch 111 is controlled by controller 110 to connect and disconnect electrical power from power source 109 to outlet 101.

Electricity vending device 100 may also send transaction information to the customer. For example, the customer may elect to receive an electronic receipt by interacting with a touch-screen keyboard of user interface 204 to enter an e-mail address and other data. Electricity vending device 100 and/or payment processing station 201 may then send an e-mail, to the email address supplied by the customer, containing a receipt and/or a statement of power provided to the customer. In an alternate embodiment, electricity vending device 100 may interact with one or more devices connected to, or in proximity of, electricity vending device 100 to supply receipt and/or transaction information. For example, software present in the customer's cellular phone may interact directly with communication interface 203 to retrieve receipt and transaction information. By providing receipt and transaction information by e-mail or text message, the expense, maintenance and size of the electricity vending device 100 is reduced since a hard-copy receipt printer is not required.

User interface 204 may also include a card reader and associated software to read and conduct transactions with magnetic stripe cards such as credit cards, debit cards, club cards, or smart cards. User interface 204 may also include wireless technology to use RFID, or other forms of electronic and/or magnetic currency. For example, payment may be carried out through software that is present within the electronic device receiving electricity from electricity vending device 100 or within another electronic device that is associated with the customer, e.g., the customer's cell phone and/or PDA. In one embodiment, one or more of a customer identification number, a fingerprint reader or retinal scanner may be used to identify the customer whose payment information is stored on payment processing station 201.

Electricity vending device 100 may also provide automated customer profiling. Customers of electricity vending device 100 may be characterized by one or more of credit card number, identification number, RFID, and biometric information such as fingerprint or retinal scan. Information attached to the customer profile by electricity vending device 100 may include e-mail address and other transaction information. Additional information may be obtained through the Internet or added to a pre-existing account, including phone number, address, and/or membership data. Customer information may be stored in a memory of controller 110 or within payment processing station 201.

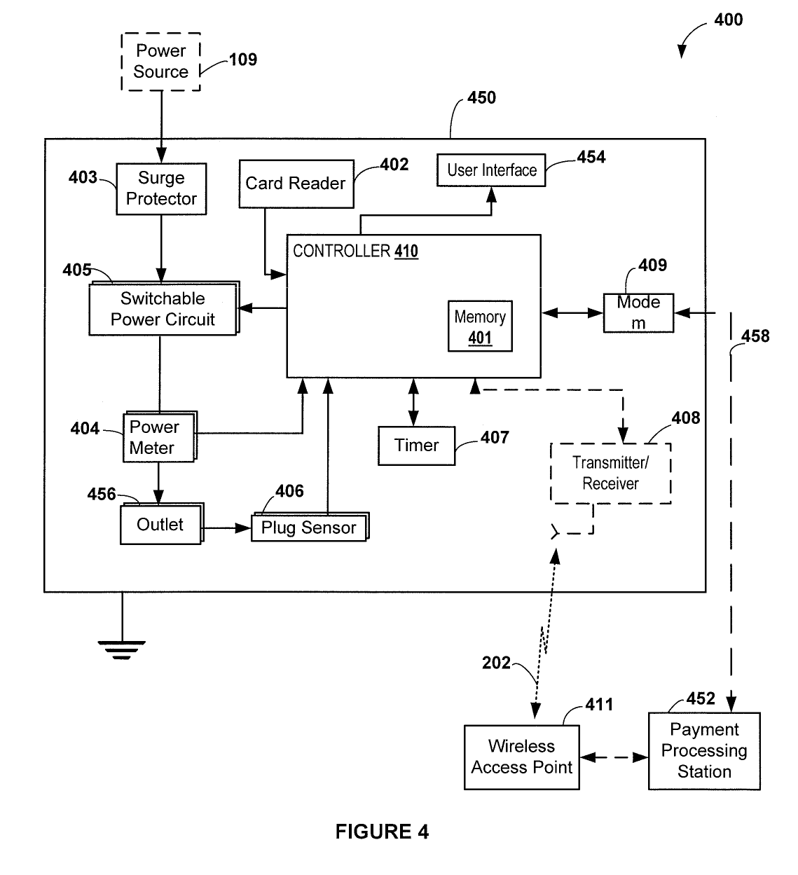

Electricity vending device 100 allows the customer to receive electrical power via outlet 101 upon receipt of payment information in a suitable form (e.g., credit card, debit card, smart card, proximity cards or keychains, or other forms of electronic or magnetic currency). Before being supplied to the customer, electrical power from power source 109 may first pass through conditioning circuitry, such as a surge protector (e.g., surge protector 403, FIG. 4). Electricity vending device 100 may also include an inverter and/or converter to condition electricity from external power source 109, if necessary.

Electricity vending device 100 may allow a predetermined amount of power to be purchased or may allow payment to be based on actual power drawn by a device connected to outlet 101. A power supply ‘session’ begins when payment information is received by electricity vending device 100 and ends when the customer disconnects a power cord from outlet 101 or when the customer or electricity vending device 100 otherwise indicate that the session is complete.

Electricity vending device 100 is a continuously operable self-service unit that allows a customer to purchase electrical power. Electricity vending device 100 may be used, for example, in airports, bus and train stations, gas stations, hotels, rental properties, campsites and other public places. Electricity vending device 100 also may be used in moving vehicles such as airplanes, trains, buses and ships.

Once installed, for example by replacing an existing electrical outlet with electricity vending device 100, electricity vending device 100 operates substantially without requiring servicing. On-site or off-site staffing may be used, but is not required, to support customer needs and operation of electricity vending device 100.

Controller 110 may be a processor, a microprocessor or any group or combination of processors or microprocessors. Controller 110 includes memory for storage of software and information, and utilizes user interface 204 to communicate with the customer. Controller 110 also communicates with payment processing station 201 though communication path 202. Controller 110 controls switch 111 to connect and disconnect electrical power to outlet 101. Switch 111 may represent one or more of an electrical relay and an electronic switching unit.

Controller 110 may receive information from a power meter (e.g., power meter 404, FIG. 4) and determine electrical power utilization by the customer. For example, controller 110 may measure power consumption by periodically measuring current drawn through outlet 101 and averaging the current over the duration of the session. Alternatively, the power meter may automatically determine power utilization, and be reset prior to a consumer session and read when the consumer session ends. Controller 110 may transmit the determined electrical power utilization to payment processing station 201, where it is converted into a fee and charged to the customer (i.e., the customer's account or payment method). In an embodiment, rates charged for power may be periodically uploaded to controller 110 such that controller 110 may display (on user interface 204) cumulative cost to the customer by periodically reading the power meter and determining a cost based upon the uploaded rate.

In an embodiment, controller 110 determines cost based upon an uploaded rate and duration of the customer's session, and the fee to be charged to the customer is transmitted to payment processing station 201.

User interface 204 may include one or more indicators (e.g., indicators 103, FIGS. 1A, 1B and 1D). Where user interface 204 includes a speaker, controller 110 may optionally include voice synthesis capability. Further, where user interface 204 includes a microphone, controller 110 may include voice recognition capability. Thus, through the use of user interface 204, controller 110 may communicate directly with the customer and provide instruction for operation of electricity vending device 100. User interface 204 may also facilitate two-way communication, using the speaker and microphone, between the customer and a customer service representative.

FIG. 1A shows a front view of a device 100(1) that includes a faceplate 102(1) supporting electrical outlet 101, indicators 103, a card reader 106 and buttons or switches 104. Electrical outlet 101 may, for example, be of type A, B, C, D, E, F, G, H, I, J, K, L or M, or it may accept a two-phase plug. Voltage/frequency supplied by electrical outlet 101 may be standard electrical voltage provided by the country in which outlet 101 is installed, such as 110V within the United States, or electricity vending device 100 may contain inverters and/or converters to produce any desired voltage. Indicators 103 may, for example, be light-emitting diodes (LEDs). Card reader 106 reads information of one or more forms of electronic or magnetic currency. In one embodiment, faceplate 102(1) has a standard size of a typical power outlet faceplate such that electricity vending device 100(1) may replace any standard size faceplate.

FIG. 1B shows a front view of an electricity vending device 100(2) that includes a faceplate 102(2) that supports outlet 101, indicators 103, buttons or switches 104, card reader 106, a display 108 and a sensor 105. Display 108 may be part of user interface 204 and may show session status information such as payment status, process status, amount of electrical power consumed, cost per unit of power, time of use and total cost. Sensor 105 may represent an RFID reader that detects an RFID tag of the customer. In one example, an RFID tag may be embedded in an electronic device (e.g., cell phone) of the customer, such that the customer may thereby be identified. In one example of operation, sensor 105 detects proximity of the RFID tag within the customer's electronic device and initiates a session for the customer.

In another embodiment, sensor 105 represents a biometric scanner, such as a fingerprint scanner or a retinal scanner, to identify a customer. Payment information associated with the identified customer may be retrieved from a remote source (e.g., payment processing station 201) to initiate a transaction.

FIG. 1C shows a side view of an electricity vending device 100(3) that includes a faceplate 102(3), card reader 106, controller 110, switch 111 and outlet 101. Controller 110 receives identification and/or payment information from card reader 106 and controls switch 111 to connect outlet 101 to power source 109. In one example of operation, a customer inserts a payment card 107, through an aperture within faceplate 102, such that payment card 107 is read by card reader 106.

FIG. 1D shows a front view of an electricity vending device 100(4) that includes two outlets 101(A) and 101(B). Payment may be associated with a particular outlet using switch 104, by detecting the presence of a plug, and/or by a user interface such as a keypad or touchscreen (not shown).

It will be appreciated that electricity vending device 100 may contain more or fewer outlets 101, indicators 103, buttons or switches 104, card readers 106, user interfaces 108 and sensors 105 without departing from the scope hereof.

In one embodiment, electricity vending device 100 is inactive until activated by a customer. Activation may occur, for example, by insertion of an electrical plug into outlet 101, by depressing button or switch 104, or by interacting with sensor 105 or user interface 204. In one embodiment, sensor 105 is one or more of an infrared (IR) detector, a radio-frequency (RF) detector, a motion sensor, a magnetic card reader, a pressure sensor and a heat sensor.

A customer session with electricity vending device 100 may terminate when an electrical plug is removed from outlet 101, when button or switch 104 is depressed by the customer, or when sensor 105 detects that the session is to terminate. Further, the session may terminate after one of (a) a defined period, (b) an amount of power consumed reaches a defined limit, (c) when a “power off” instruction is received from the customer or the customer's device, and (d) a total cost value is reached. In one example, a customer elects to pay for a fixed amount of electricity. In another example, a customer elects to pay for a fixed period of use. In another example, a customer elects to pay for an amount of electricity drawn during a period a device is connected to outlet 101 of electricity vending device 100.

In one embodiment, a device being charged by electricity vending device 100 communicates (e.g., wirelessly via user interface 204 and/or sensor 105) with controller 110 to indicate when its battery is fully charged. For example, many devices, such as cell phones and computers, are equipped to monitor their battery power level and provide an indication of the level to a user. Such devices could be configured to communicate with electricity vending device 100 and/or payment processing station 201, e.g., via Bluetooth®, infrared, or through a power/charging cable, to instruct electricity vending device 100 to stop supplying power when the battery is fully charged. In another example, where the battery of the device connected to electricity vending device 100 is intelligent, the battery itself may send a signal to electricity vending device 100 to switch off outlet 101.

In another example, electricity vending device 100 may include a reference circuit that compares a reference voltage or current to the voltage or current being drawn by an attached device to determine when the battery of the device is full.

In another embodiment, electricity vending device 100 provides a DC charging voltage to a battery of an external device and, by monitoring the current and/or voltage of the supplied electricity, electricity vending device 100 may determine when the connected battery is full, and thereby when to disconnect outlet 101 from external power source 109.

Each electricity vending device 100 may have a unique digital identification such as, but not limited to, an IP address, MAC address or Ethernet Hardware address.

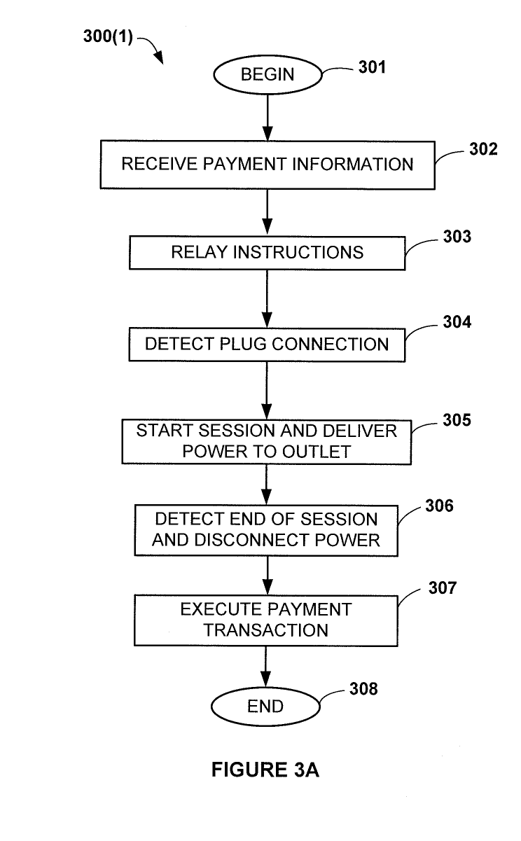

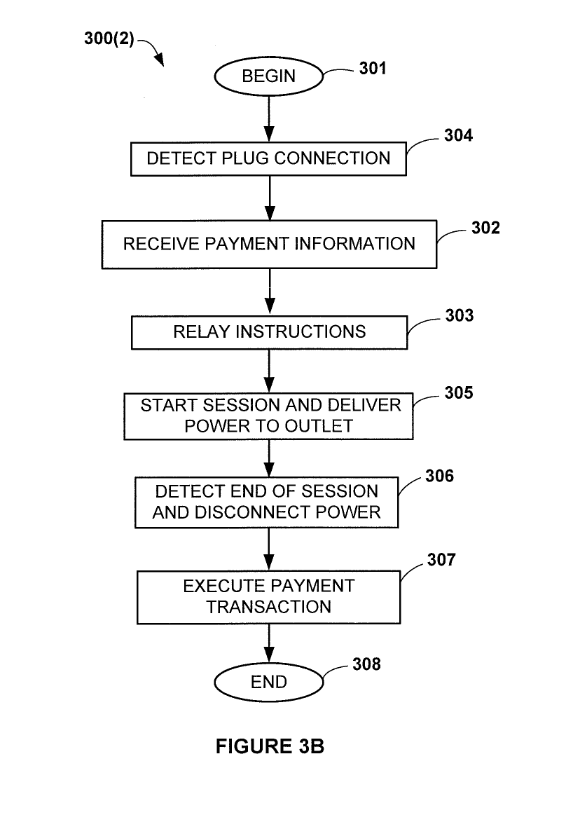

Referring to FIG. 3A, a flowchart of an exemplary transaction method 300(1) for use by electricity vending device 100 is shown. Transaction method 300(1) begins with step 301 when electricity vending device 100 is powered on. In step 302, payment information is received and optionally verified. In step 303, instructions are relayed to the customer via user interface 204. A plug inserted into outlet 101 is detected in step 304 and power is delivered to outlet 101 in step 305, thereby starting the customer's session. The transaction is terminated, in step 306, when the end of the customer's session is detected (e.g., after a predetermined time has expired, when a predetermined fee has been reached, when the user takes affirmative action to cease the transaction, when the external device indicates that its battery is fully charged, or when the external device is disconnected). In step 307, method 300(1) executes a payment transaction for the customer's session. The method ends with step 308.

Various modifications, particularly in the order of steps performed, may be made to method 300(1). For example, FIG. 3B shows method 300(2) where step 304 of detecting a plug inserted into outlet 101 is performed prior to steps 302 and 303.

FIG. 4 shows one exemplary electricity vending system 400 that includes an electricity vending device 450, a payment processing station 452, and an interne access point 411. Electricity vending device 450 includes a controller 410, a card reader 402, a surge protector 403, a power meter 404, a switchable power circuit 405, a plug sensor 406, a timer 407, an optional transmitter/receiver 408, a modem 409, a user interface 454, and an outlet 456.

Card reader 402 receives payment information from a customer, and transfers the information to controller 410, which operates to control electricity vending device 450. Either immediately or at set intervals, controller 410 communicates the payment information to payment processing station 452, where the payment information may be verified. Controller 410 may communicate with payment processing station 452 using modem 409 and communications path 458 (which may represent an electrical line of power source 109 or a telecommunication path, such as a phone line), or using wireless transmitter/receiver 408 that communicates with a wireless access point 411 connected to the Internet, and in turn to payment processing station 452. Modem 409 may represent a telephone line modem or a power line modem. Upon receipt of payment information and, optionally verification, controller 410 activates switchable power circuit 405 to supply power to outlet 456 from power source 109. Electrical power from source 109 may pass through surge protector 403 that operates to provide electrical protection to device 450 and any electrically connected device against surges and spikes in electrical power.

A power meter 404 measures the amount of electrical power flowing to outlet 456 and communicates this information to controller 410 upon request. Plug sensor 406 detects presence or absence of an electrical plug within outlet 456. Sensor 406 may, for example, be an electrical detection circuit that is shorted when a plug is removed from outlet 456, or it may be an optical sensor that is occluded when a plug is inserted into outlet 456. Timer 407 may be used by controller 410 to measure the duration of a customer session. User interface 454 allows controller 410 to interact with the customer and may be used to provide information to the customer throughout the session.

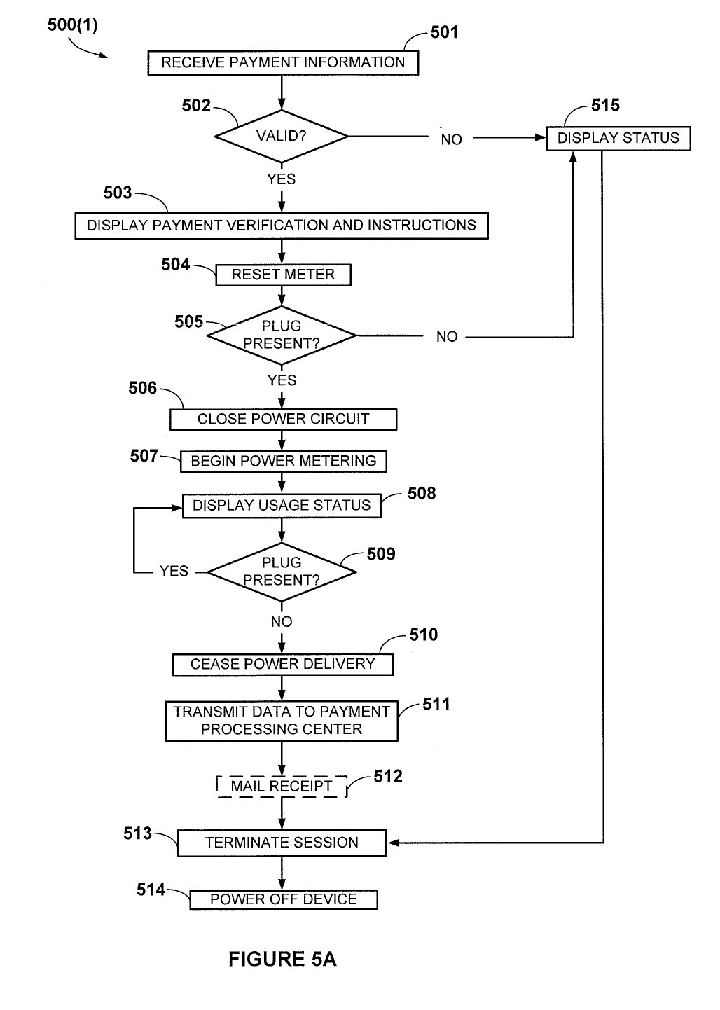

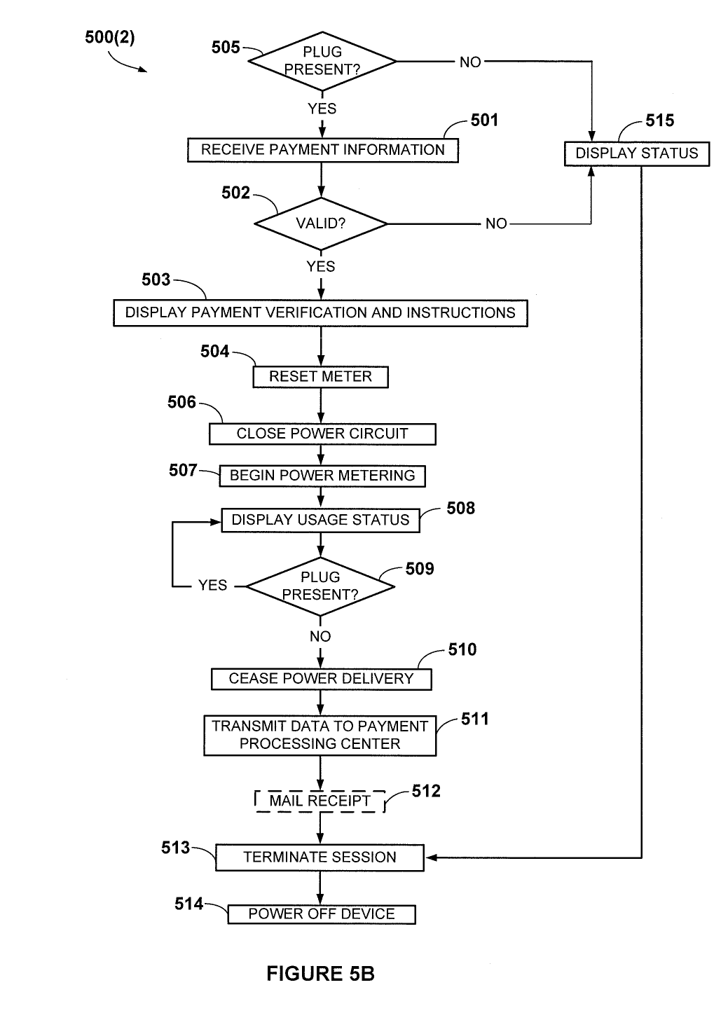

FIG. 5A is a flowchart of an exemplary electricity vending method 500(1) for use by electricity vending devices 100 and 450. Payment information is received in step 501 via a card reader (e.g., card readers 106, 402). Step 502 is a decision to determine whether the payment information of step 501 is valid. If payment processing station 201, 452 determines that the payment information is invalid, the status of the payment is displayed, in step 515, and the session is terminated in step 513. If the payment information is valid, payment verification and instructions are displayed to the customer on user interface 108, 454 in step 503. Power meter 404 is reset in step 504. Step 505 is a decision to determine whether plug sensor 406 has detected the presence of a plug in outlet 101, 456. If a plug is not detected, user interface 454 displays status to the customer, in step 515, and the session is terminated, in step 513. If a plug is detected, switchable power circuit 111, 405 is activated to initiate flow of electricity to outlet 101, 456, in step 506. Power meter 404 and/or timer 407 begin to meter power consumption in step 507. Power usage is displayed in step 508. Step 509 is a decision to determine whether plug sensor 406 continues to sense the presence of a plug in outlet 101, 456. If a plug is detected, method 500(1) repeats steps 508 and 509; i.e., steps 508 and 509 repeat until no plug is detected, or, optionally, until a maximum time, power consumption, or cost has been reached. If no plug is detected in step 509, switchable power circuit 111, 405 is deactivated to stop power delivery to outlet 101, 456 in step 510. Controller 110, 410 records the transaction information to memory (e.g., memory 401) and transmits the data to payment processing station 201, 452, in step 511. Step 512 is optional. In step 512, if included, an electronic receipt is generated by controller 110, 410 and/or payment processing station 201 and sent to the customer's e-mail address or text message address. In step 513, the session is terminated and device 100, 450 powers off or activates an energy-saving mode, in step 514. For example, the session may be terminated when a user takes affirmative action to end the transaction such as pressing a button, when sensor 406 detects the absence of a plug, when a predetermined fee has been reached, when the external device indicates that its battery is fully charged, or after a predetermined period of use or non-use.

Various modifications, particularly in the order of steps performed, may be made to method 500(1). For example, FIG. 5B shows an embodiment where step 505 of detecting a plug is performed first.

Electricity vending devices described herein may be configured to fit in spaces designed for standard electrical outlets, outlet boxes, and outlet faceplates. For example, electricity vending device 100, 450 may be configured to replace a standard power outlet, and may have a two-dimensional area of about 2.75 inches×4.5 inches, which corresponds to a standard single or duplex wall socket faceplate. For a combination switch duplex socket, faceplate 102 may have a two-dimensional area of about 5 inches×5 inches. Existing electrical outlet boxes may be, but are not limited to, single gang, two gang, three gang, round, octagonal or square. The three dimensional footprint of electricity vending device 100, 450 for a single gang outlet box may be, for example, around 2 inches in width, around 4 inches in height, and around 3 inches in depth. For a two gang outlet box, the three dimensional footprint of electricity vending device 100, 450 may be, for example, about 4 inches in width, about 4 inches in height, and about 3 inches in depth. For a three gang outlet box, the three dimensional footprint of electricity vending device 100, 450 may, for example, have a volume of about 46 cubic inches. Overall, electricity vending device 100, 450 may be adapted to have a width between about 1.5-6 inches, a height between about 3-4 inches, and a depth between about 1.5-4 inches.

The description of the specific embodiments reveals general concepts that others can modify and/or adapt for various applications or uses that do not depart from the general concepts. Therefore, such adaptations and modifications should and are intended to be comprehended within the meaning and range of equivalents of the disclosed embodiments. It is to be understood that the phraseology or terminology employed herein is for the purpose of description and not limitation.

All references mentioned in this application are incorporated by reference to the same extent as though fully replicated herein.

What is claimed is:

1. An electricity vending device comprising:
an electrical outlet for supplying electricity to a user;
a user interface for receiving payment information;
a controller;
a switch responsive to the controller for connecting and disconnecting the electricity to and from the electrical outlet;
a meter or a timer for measuring an amount of electricity supplied to the electrical outlet; and
a communication interface for sending the payment information and the amount of electricity to a payment processor.

2. The device of claim 1 wherein the electricity vending device is adapted to have a two-dimensional area of 2.75 inches×4.5 inches.

3. The device of claim 1 wherein the electricity vending device is adapted to have a two-dimensional area of 5 inches×5 inches.

4. The device of claim 1 wherein the electricity vending device is adapted to have a width between 1.5-6 inches, a height between 3-4 inches and a depth between 1.5-4 inches.

5. The device of claim 1 wherein the communication interface comprises a wireless transceiver for wirelessly communicating with the payment processor.

6. The device of claim 1 wherein the communication interface comprises a transceiver for communicating with the payment processor over a wired connection.

7. The device of claim 1 further comprising a sensor for detecting the presence or absence of a plug inserted into the electrical outlet.

8. The device of claim 7 wherein the sensor is selected from an optical sensor and an electrical detection circuit.

9. The device of claim 1 further comprising a payment device selected from the group consisting of a magnetic card reader, a fingerprint scanner, a retinal scanner, a keypad, a touchscreen, a button, and an RFID detector.

10. A method for distributing electricity from an electricity vending device to an external electrical device comprising:
detecting the presence or absence of a plug in an electrical outlet;
receiving payment information;
supplying electricity to the electrical outlet; and
terminating a transaction.

11. The method of claim 10 wherein the step of terminating the transaction occurs when the absence of the plug in the electrical outlet is detected.

12. The method of claim 10 further comprising verifying the payment information.

13. The method of claim 10 further comprising:
determining an amount of electricity supplied to the electrical outlet; and
charging a customer for the amount of electricity supplied.

14. The method of claim 13, wherein the step of charging the customer comprises sending payment information and the amount of electricity supplied to a payment processor.

15. The method of claim 10 further comprising providing an electronic receipt to the customer.

16. A software product comprising instructions, stored on computer-readable media, wherein the instructions, when executed by a computer, perform steps for vending electricity, comprising:
instructions for detecting the presence or absence of a plug;
instructions for receiving payment information;
instructions for delivering power to an outlet; and
instructions for terminating an electricity vending transaction.

17. The software product of claim 16 further comprising instructions for verifying payment information.

18. The software product of claim 16 further comprising instructions for measuring power usage.

19. The software product of claim 16 further comprising instructions for transmitting data to a payment processing center.

20. The software product of claim 16 further comprising instructions for providing an electronic receipt to a customer.
